(19) United States
(12) Patent Application Publication
(10) Pub. No.: US 2007/0180685 A1
(43) Pub. Date: Aug. 9, 2007

(54) Method for producing a winding support for an electrical machine

(76) Inventor: Samir Mahfoudh, Buehl (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/592,942

(22) PCT Filed: Jan. 24, 2005
(86) PCT No.: PCT/EP05/50296

§ 371 Date: Sep. 15, 2006

(30) Foreign Application Priority Data
Mar. 17, 2004 (DE) 10 2004 012 925.8

(51) Int. Cl. H02K 1/00; H02K 15/00; H01F 7/06

(52) U.S. Cl. 29/606; 29/596; 310/180; 310/216

(57) ABSTRACT

A method for producing a winding support for an electrical machine, in which the winding support has a plurality of pole teeth. Adjacent pole teeth between them define at least one slot which is filled with at least one winding each. The pole teeth before being filled, have an installation position relative to one another for installation into the electrical machine. At least one of the pole teeth which define a slot, is bent, before the filling of the at least one slot with the winding, by a force action into a filling position, so that the cross-sectional area of the at least one slot that it defines is increased. Then the winding is placed in the slot. Next, the at least one of the adjacent pole teeth is put out of the filling position into the installation position. As a result, a higher copper factor and thus higher power of the machine can be attained.

### PRIOR ART

The invention is based on a method for producing a winding support for an electrical machine as generically defined by the preamble to claim 1. A winding support of this kind has a plurality of pole teeth. Between them, adjacent pole teeth define at least one slot, into which at least one winding each is inserted. Even before the slots are filled with the winding, the pole teeth are in the later installation position relative to one another for installation in the electrical machine. The winding is also inserted in this installation position. As a result, copper factor that the winding support or the electrical machine can maximally have is already defined. The copper factor is also an indicator for the motor power.

### ADVANTAGES OF THE INVENTION

The method of the invention for producing a winding support for an electrical machine having the definitive characteristics of claim 1 has the advantage that compared to a winding support of comparable structural size, greater power can be attained because of the higher copper factor. To that end, a method for producing a winding support for an electrical machine is provided, in which the winding support has a plurality of pole teeth, and adjacent pole teeth between them define at least one slot, which is filled with at least one winding each, and the pole teeth, before being filled, have an installation position relative to one another for installation into the electrical machine, and at least one of the pole teeth, which define a slot, is bent, before the filling of the at least one slot with the winding, by a force action into a filling position, so that the cross-sectional area of the at least one slot that it defines is increased, and then the winding is placed in the slot, and after that next, the at least one of the adjacent pole teeth is put out of the filling position into the installation position.

Preferably, the force action engages the pole teeth directly.

It is advantageous if all the pole teeth are successively bent into the filling position and after the insertion of the respective winding are put in the installation position, since thus all the slots have a higher copper factor.

In a preferred refinement of the invention, the at least one pole tooth, which is bent, is bent in the elastic region, and after the insertion of the winding, by withdrawal of the force action, returns to the installation position by means of its intrinsic elasticity. As a result, the method is relatively easy to use, since no effort is required to orient the pole teeth dimensionally precisely.

In a further preferred refinement of the invention, the at least one pole tooth, which is bent open, is bent in the plastic region and after the insertion of the winding, by a reversal of the force action, is returned to the installation position by plastic deformation. As a result, even higher copper factors can be achieved.

It is advantageous if directly adjacent pole teeth are bent open into a filling position, by increasing the spacing between them, since as a result a symmetrical force action is possible, and above all greater filling of the slot is possible.

If pole teeth, between which one further pole tooth is disposed, are bent open by increasing the spacing between them, then either two adjacent slots can be simultaneously provided with windings, or a single-toothed winding can be applied to the pole tooth located between them.

The best filling with a winding can be achieved if the pole teeth of two paired slots receiving at least this winding are bent open, and then the winding is inserted, and next, in the clockwise or counterclockwise direction, the pole teeth of respective paired slots receiving at least one winding and following one another directly or indirectly are bent open, until the winding support is completely provided with windings.

The method can be used especially appropriately if the pole teeth each include one tooth neck and one tooth head, and the tooth heads have portions which protrude transversely to the tooth necks and which define undercuts of undercut slots for receiving windings and form utility slits, and for insertion of the windings, essentially at least the width of the utility slit is increased. Because of the undercut, an especially large number of turns of the winding can be inserted.

A winding support which is produced by such a method has an especially high copper factor.

If in a winding support of this kind, at least the transition from the slot base located between two pole teeth to the pole teeth is embodied as essentially sharp-edged, the result is a lower resistance moment of the pole teeth. As a result, the force necessary for the bending is reduced. In winding supports in which the pole teeth each include one tooth neck and one tooth head, and the tooth heads have portions, protruding transversely to the tooth necks, that form undercuts of undercut slots, and the transitions from the tooth necks to the undercuts are embodied as essentially sharp-edged, this effect is further amplified. In addition, these provisions have the advantage that because of a permanent increase in the cross-sectional area of the slots, a greater volume for windings is created.

In a preferred refinement, such a winding support is an armature of an internal rotor or a stator of an external rotor, in which the pole teeth are oriented radially outward, since in this case the pole teeth are easily bent open.

An electrical machine having a winding support of this kind, compared to an electrical machine of comparable structural size, has greater power because of the higher copper factor.

The method is easily performed with an apparatus for performing the method, which has at least one device for bending at least one pole tooth.

An additional improvement in the apparatus is attained if the apparatus has at least one device for bending two adjacent pole teeth. Thus a slot can be bent open even wider.

A further improvement in this apparatus is attained if the apparatus has at least one device which bends two pole teeth of two slots into which one winding is inserted. As a result, especially pairs of slots each receive one winding can easily be bent open.

Further advantages and advantageous refinements will become apparent from the dependent claims and the description.

### DRAWING

One exemplary embodiment is shown in the drawing and described in further detail in the ensuing description. Shown are:

FIG. 1, an electrical machine in cross section;

FIG. 2, an armature of FIG. 1;

FIG. 3, the armature of FIG. 1 with windings shown symbolically; and

FIG. 4, the armature of FIG. 1, on an apparatus, shown highly simplified, for performing the method.

### DESCRIPTION OF THE EXEMPLARY EMBODIMENT

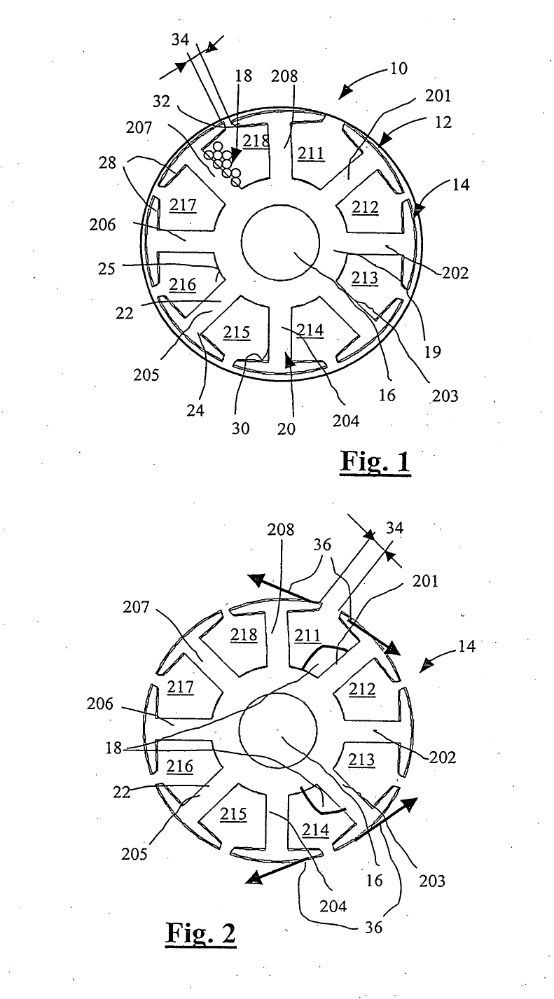

In FIG. 1, a rotating electrical machine 10 is shown in simplified form in cross section. The electrical machine 10 may be an electric motor, which is used in a motor vehicle for instance in a seat adjuster, power window systems, wiper drive, and so forth. However, it may also be a generator.

An armature 14 is disposed in the housing 12 and is located on a shaft 16. The armature 14, with or without the shaft 16, thus acts as a winding support for an electrical machine 10. The armature 14 is produced as a lamination packet made of sheet metal or of so-called SMC (soft magnetic composite) material. In a sheet-metal lamination packet, the thickness of a single sheet (represented by reference numeral 14) is 0.5 mm, which can include deviations within the range of tenths of millimeters.

The armature 14 has a plurality of windings 18. For the sake of greater clarity, only one winding 18 is shown schematically in FIG. 1. A plurality of pole teeth 20 protrude radially outward from a circular portion 19 of the armature 14 and define or form slots 21 for receiving the windings 18. In the present exemplary embodiment, there are specifically eight pole teeth 201, 202, 203, 204, 205, 206, 207, 208. Correspondingly, there are also eight slots 211, 212, 213, 214, 215, 216, 217, 218. Naturally still other numbers are possible. The pole teeth 20 each include one tooth neck 22, which originates at the portion 19, and one tooth head 24, which adjoins the tooth neck 22. Between the tooth necks 22, the slot base 25 of a slot 21 is embodied on the outer circumference of each portion 19.

The transition from the slot base 25 to the tooth necks 22 or pole teeth 20 is embodied as essentially sharp-edged; that is, it is not, as is usually done, rounded. In the ideal case, the transition is entirely sharp-edged. However, a transition radius of less than 1 mm is still acceptable, and a transition radius of less than 0.5 mm is to be preferred. Preferably, the transition is indeed sharp-edged. A radius which is less than the thickness of a single sheet (also reference numeral 14) of the armature 14, however, still leads to good results in bending. The thickness is typically approximately 0.5 mm, for example, but it may amount to a few tenths of a millimeter more or less.

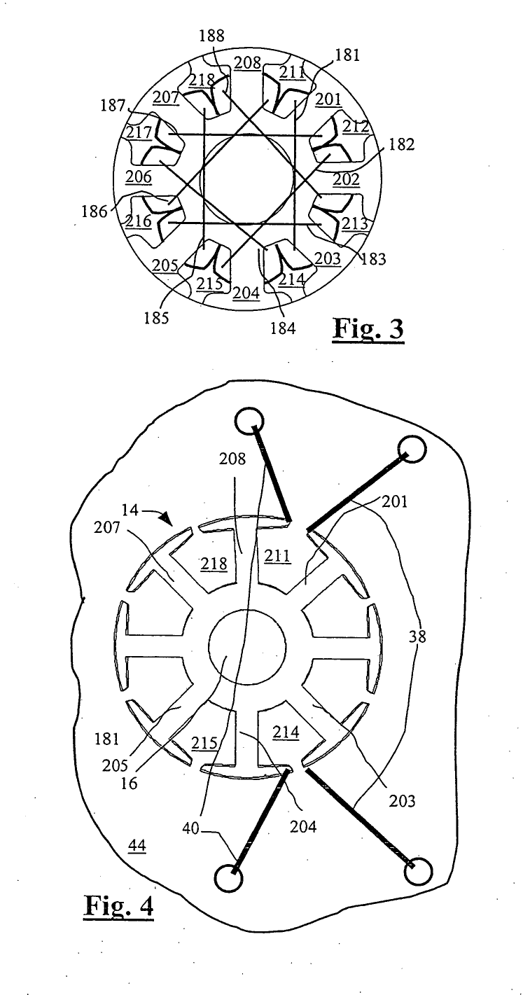

The slot 211, with the slot 214, together as a pair receive one common winding 18. The same is true for the slots 212 and 215; 213 and 216; 214 and 217; 215 and 218; 216 and 211; 217 and 212; and finally, 218 and 213; this will be explained in more detail in conjunction with FIG. 3.

The tooth necks 22 are preferably distributed uniformly over the circumference of the armature 14 and protrude in a straight line; that is, they do not have a curved course. However, it is also conceivable for them to have a curved course. The tooth necks 22 also have an essentially constant width. Alternatively, however, the width may vary; that is, it may become narrower or wider from the inside outward.

The tooth heads 24 have portions 28 protruding transversely to the tooth necks 22 and pointing away from each other. The portions 28 form undercuts 30, which define the thus-undercut slots 21. The portions also define utility slits 32, which have a width 34.

The transition from the tooth necks 22 to the undercuts 30 is embodied as essentially sharp-edged; that is, it is not, as is usually done, rounded. In the ideal case, the transition is entirely sharp-edged. However, a transition radius of less than 1 mm is still acceptable, and a transition radius of less than 0.5 mm is to be preferred. Preferably, the transition is indeed sharp-edged. A radius which is less than the thickness of a single sheet (also reference numeral 14) of the armature 14, however, still leads to good results in bending. The thickness is typically approximately 0.5 mm, for example, but it may amount to a few tenths of a millimeter more or less.

The method for producing the armature 14 for the electric motor 10 will now be explained in further detail in conjunction with FIG. 2.

Initially, after the production of the stamped lamination packet, the pole teeth 20 of the armature 14 are still in the installation position shown in FIG. 1. In the installation position, the armature 14 can be introduced into the electric motor 10.

Before the filling with the winding 18, however, the directly adjacent pole teeth 208 and 201 as well as 203 and 204 are spread apart. Thus the slots 211 and 214 defined by the respective pairs of pole teeth 208 and 201 as well as 203 and 204 are enlarged. This increase in the cross-sectional area of the slots 211 and 214 is accomplished for instance with a tool which engages recesses on the circumference of the pole teeth 20, and a force action represented by arrows 36 can take place. This will be described in further detail in conjunction with FIG. 4. The position then reached by the pole teeth 20 will hereinafter be called the filling position. Now the winding 18 can be made either by being wound itself or by the insertion of a prefabricated air coil. Inserting an air coil is advantageous whenever the slots 21 are not undercut, and the pole teeth 20 have no tooth head 24. However, the method is preferably employed with the pole teeth 20 shown, which each have one tooth neck 22 and one tooth head 24 with the portions 28 protruding transversely to the tooth neck 22 and forming the utility slits 32. In that case, for inserting the windings 18, essentially at least the width 34 of the utility slit 32 is increased.

Since the cross-sectional area of the slots 21 is increased, a greater number of turns of the windings 18 can be introduced. Once the winding 18 has been inserted, the force action is withdrawn again. As a result, the respective pairs of pole teeth 201 and 208, and 204 and 205, approach one another again. Because of the air between the turns of the winding 18, the winding 18 can also be compressed a little, without destroying the insulation layer of the copper wires.

After the first pole tooth pairs 208 and 201 as well as 203 and 204, the armature 14 is rotated 360°, divided by the number of slots 21, or in other words 45°—either clockwise or counterclockwise, but as shown in FIG. 2 counterclockwise—and the pole teeth 201 and 202 as well as 204 and 205 are put in the filling position. The slots 212 and 215 located between them are provided with the winding 18 and put back in the installation position. Following that, the pole teeth 202 and 203 as well as 205 and 206 are spread apart; the slots 213 and 216 located between them are provided with the winding 18 and are likewise put back in the installation position. After that, the same process is repeated for the pole teeth 203 and 204 as well as 207 and 208. Thus all the pole teeth 20 are successively bent into the filling position, and after the insertion of the respective winding 18, they are put in the installation position. This is done another four times, until in every slot 21, the left and right side has been wound. Hence finally, the entire armature 14 will have been provided with windings 18. In terms of the order of filling, once again see the details on FIG. 3 below.

Accordingly, the pole teeth 20 of each two slots 21 receiving a winding are bent open, the windings 18 are then inserted, and next, in the clockwise or counterclockwise direction, the pole teeth 20 of each of the following pairs of slots 21 receiving one winding 18 are bent open, until the armature 14 has been completely provided with windings 18.

After the withdrawal of the force action, the pole teeth 20 return to their installation position. The reason for this is that the pole teeth 20 that are each bent are bent in the elastic region, and after the insertion of the winding 18, by withdrawal of the force action, they return to the installation position because of their intrinsic elasticity, or are returned to the installation position because of their intrinsic elasticity.

Alternatively, it is also possible for the pole teeth 20 that are bent open to be bent in the plastic region instead of the elastic region—or with some components in the elastic and plastic region—and after the insertion of the winding 18 to be returned by plastic deformation to the installation position by a reversal of the force action 36. Since as a result of the bending open in the plastic region the pole teeth 20 are spread farther apart than in the elastic region, the cross-sectional area of the slots 21 is also greater in each case, and as a result there is space for more turns in the winding 18.

Besides the directly adjacent pole teeth 20, pole teeth 20 between which at least one further pole tooth 20 is disposed can also be bent open, by increasing the spacing between them. For instance, the pole teeth 201 and 203 can be bent open, while the pole tooth 202 is initially not bent. At the same time, the pole teeth 205 and 207 can also be bent, while the pole tooth 206 is likewise initially not bent. In the present situation, these pole teeth are considered to be indirectly adjacent. Then, one winding 18 is placed in the slots 211 and 214, and simultaneously one winding 18 is inserted into the slots 218 and 215. After that, the armature 14 is rotated 360° clockwise or counterclockwise, divided by the number of slots 21, or in other words is rotated onward by 45°. However, because it is double-wound, the armature 14 needs to be rotated only three times.

What is essential is that at least one of the pole teeth 20 that define one slot 21 be bent by a force action into a filling position before the filling of the slot 21 with the winding 18, so that the cross-sectional area of at least one slot 21 that this pole tooth defines is increased; that then the winding 18 is inserted into the slot 21; and that next, the at least one of the adjacent pole teeth 20 is put out of the filling position into the installation position.

FIG. 3 shows the finished arrangement of the windings 18 in the slots 21, in the way that is already known from the prior art, still more clearly:

the winding 181 is wrapped around the pole teeth 201 and 203 and is located in the slots 211 and 214;

the winding 182 is wrapped around the pole teeth 202 and 204 and is located in the slots 212 and 215;

the winding 183 is wrapped around the pole teeth 203 and 205 and is located in the slots 213 and 216;

the winding 184 is wrapped around the pole teeth 204 and 206 and is located in the slots 214 and 217;

the winding 185 is wrapped around the pole teeth 205 and 207 and is located in the slots 215 and 218;

the winding 186 is wrapped around the pole teeth 206 and 208 and is located in the slots 216 and 211;

the winding 187 is wrapped around the pole teeth 207 and 201 and is located in the slots 217 and 212;

the winding 188 is wrapped around the pole teeth 208 and 202 and is located in the slots 218 and 213.

Here, the windings 18 have been successively filled in the order of 181, 182, 183, 184, 185, 186, 186, 188. In the process, both pole teeth 20 defining one slot 21 have been bent open. The advantage here is that the slot 21 can be bent open wider, which allows a higher filling position.

Alternatively, the following filling positions can be parallel-wound: 181 and 185; 182 and 186; 183 and 187; and 184 and 188. Here the advantage is that two windings 18 can be filled simultaneously, which reduces the process time.

Naturally, the order described is only an example and need not be adhered to. Many variations are known.

In FIG. 4, it is shown how the pole teeth 201, 208 and 203, 204 are bent open with two pairs of pliers 38, 40 of an apparatus 42, shown only symbolically and as a fraction or in part, for performing the described method. The apparatus 42 should have at least one device 38, 40 for bending at least one pole tooth 20, because it is also possible for only the pole tooth 201, for instance, to be bent. Preferably, however, the apparatus 42 has at least one device in the form for instance of a part such as a hook of the pliers 38 or 40 for bending two adjacent pole teeth 201 and 208 of the slot 211. It is even better, however, if the apparatus 42—as shown—has at least one device 38, 40 which bends two pole teeth 201, 208 and 203, 204 of two respective slots 211 and 214, into which paired slots one winding 18 is placed. The pliers 38, 40 may also bend open the pairs of pole teeth 201, 207 and 203, 204, and the pole teeth 204 and 208 remain straight, so that one winding 18 can be inserted into the pairs of slots 211, 214 and 218, 215. Naturally the other slots 21 are then wound in succession, as described above. The fixation of the armature 14 can be done for instance via the shaft 16.

The invention is not limited to winding supports in the form of the armature 14. As can be seen directly from the description, instead of an armature, it may be a stator of an external rotor motor, or of a generator. The pole teeth moreover need not point radially outward as shown. For instance, they can point inward from a larger wound portion 19, as is the case for instance in stators of generators or electronically commutated electric motors.

1-17. (canceled)

18. A method for producing a winding support for an electrical machine, the winding support having a plurality of pole teeth, and adjacent pole teeth between them define at least one slot which is filled with at least one winding each, the pole teeth, before being filled, having an installation position relative to one another for installation into the electrical machine, the method comprising bending least one of the pole teeth, which define a slot, before the filling of the at least one slot with the winding, by a force action into a filling position, so that the cross-sectional area of the at least one slot that it defines is increased; placing the winding in the slot; and then returning the at least one of the adjacent pole teeth from the filling position into the installation position.

19. The method as defined by claim 18, wherein the force action engages the pole teeth directly.

20. The method as defined by claim 18, wherein one pole teeth are bent successively into the filling position and after the filling of the slots with windings are put in the installation position.

21. The method as defined by claim 18, wherein the at least one pole tooth, which is bent, is bent in the elastic range, and after the insertion of the winding, by withdrawal of the force action, returns to the installation position by means of its intrinsic elasticity.

22. The method as defined by claim 18, wherein the at least one pole tooth, which is bent open, is bent in the plastic range and after the insertion of the winding, by a reversal of the force action, is returned to the installation position by plastic deformation.

23. The method as defined by claim 18, wherein directly adjacent pole teeth are bent open into a filling position by increasing the spacing between them.

24. The method as defined by claim 18, wherein pole teeth between which at least one further pole tooth is disposed, are bent open by increasing the spacing between them.

25. The method as defined by claim 18, wherein at least the pole teeth of two paired slots that receive at least one winding are bent open and then the slots are filled with the winding; wherein the pole teeth are returned to the installation position; and wherein in the clockwise or counterclockwise direction the pole teeth of respective following paired slots that receive at least one winding are bent open, until the winding support has been completely provided with windings.

26. The method as defined by claim 18, wherein the pole teeth each include one tooth neck and one tooth head, and the tooth heads have portions which protrude transversely to the tooth necks and which define undercuts of undercut slots for receiving windings and form utility slits, and for insertion of the windings, essentially at least the width of the utility slit is increased.

27. A winding support produced by the method as defined by claim 18.

28. The winding support as defined by claim 27, wherein at least the transition from the slot base located between two pole teeth to the pole teeth is embodied as essentially sharp-edged.

29. The winding support as defined by claim 27, wherein the pole teeth each include one tooth neck and one tooth head, and the tooth heads have portions, protruding transversely to the tooth necks, that form undercuts of undercut slots, and the transitions from the tooth necks to the undercuts are embodied as essentially sharp-edged.

30. The winding support as defined by claim 28, wherein the pole teeth each include one tooth neck and one tooth head, and the tooth heads have portions, protruding transversely to the tooth necks, that form undercuts of undercut slots, and the transitions from the tooth necks to the undercuts are embodied as essentially sharp-edged.

31. The winding support as defined by claim 27, wherein the winding support is an armature of an internal rotor or a stator of an external rotor, and the pole teeth are oriented radially outward.

32. The winding support as defined by claim 28, wherein the winding support is an armature of an internal rotor or a stator of an external rotor, and the pole teeth are oriented radially outward.

33. The winding support as defined by claim 29, wherein the winding support is an armature of an internal rotor or a stator of an external rotor, and the pole teeth are oriented radially outward.

34. An electrical machine having a winding support as defined by claim 27.

35. An apparatus for performing the method as defined by claim 18, the apparatus comprising at least one device for bending at least one pole tooth.

36. The apparatus as defined by claim 35, further comprising at least one device for bending two adjacent pole teeth.

37. The apparatus as defined by claim 35, further comprising at least one device which bends two pole teeth of two slots into which one winding is inserted.
